(19) United States
(12) Patent Application Publication
(10) Pub. No.: US 2026/0214410 A1
(43) Pub. Date: Jul. 23, 2026

(54) Method and Apparatus for Visualizing and Controlling Sounds in a Surround Sound Audio Mix

(71) Applicant: Sound of Light, Inc., Sausalito, CA (US)

(72) Inventor: David A. Gibson, Sausalito, CA (US)

(73) Assignee: Sound of Light, Inc., Sausalito, CA (US)

(21) Appl. No.: 19/452,781

(22) Filed: Jan. 19, 2026

Related U.S. Application Data
(60) Provisional application No. 63/747,337, filed on Jan. 20, 2025.

(51) Int. Cl. H04S 7/00; G06F 3/16; H04S 3/00

(52) U.S. Cl. CPC H04S 7/40; G06F 3/165; H04S 3/008; H04S 7/30; H04S 2400/01

(57) ABSTRACT

Surround sound mixing. Audio channels are represented in a 3D space on a user interface as a visual object. Each visual object has multiple visual components, and individual audio characteristics of a sound, such as volume, panning, or frequency, are correlated with a specific visual component of the visual object. By correlating audio characteristics to visual components, a change made to a visual component of the visual object makes a proportional change in the corresponding an audio characteristic, and conversely, a change made to an audio characteristic makes a proportional change in the corresponding a visual component of the visual object.

### BACKGROUND

The invention relates generally to method and apparatus for visualizing and controlling sounds in a surround sound audio mix.

Currently, there are a number of solutions for mixing surround sound music with software. Some of these solutions provide tools that look like a mixing board, but fail to meet the needs of the industry because they are one logical step from actually seeing and controlling the sounds between the speakers. Other solutions have attempted to visualize sounds between the speakers showing only panning instead of all audio parameters, which makes it impossible to see the relationship between the various audio parameters, which is the core essence of what is used to create great audio mixes. These solutions are therefore unable to meet the needs of the industry because they provide little usable information about the mix. Using images of a mixing board on the computer screen to create a mix of sounds between the speakers can be a barrier for learning how to mix since it typically requires a large amount of time to learn the process.

Some previous systems have used visuals for stereo mixing but have failed to use visual systems for surround sound mixing.

No system has ever shown automation in way where all parameters of sound and their relationships can be seen in the Line Automation section of the mixing software. The relationship of audio parameters is critical for ease of mixing and creating great audio mixes.

### BRIEF DESCRIPTION OF THE DRAWINGS

FIG. 1 shows the size of the sphere based on volume.

FIG. 2 shows the fader attached to a sound sphere with corresponding calibrated volumes and size.

FIG. 3 shows a fader attached to a sound sphere with calibrated volumes and size.

FIG. 4 shows a calibrated 3D grid calibrated to panning and frequency placement of a sound.

FIG. 5 shows automation of all sound parameters visualized on a time axis.

FIG. 6 shows movement possibilities of automation parameters in the visual space between the speakers.

FIG. 7 shows a geometrical automation preset of multiple audio parameters in the visual space between the speakers.

FIG. 8 shows bands of color corresponding to frequency ranges mapped on to the sphere showing the harmonic structure of the sound itself and all equalization parameters.

FIG. 9 is a simplified signal flow diagram in a first audio environment.

FIG. 10 is a simplified signal flow diagram in a second audio environment.

### DETAILED DESCRIPTION

The present invention is directed to methods and apparatus for visualizing and controlling sounds in a surround sound audio mix.

A computerized process is disclosed for surround sound mixing with audio equipment. This computer process is made up of various executable steps that correlate an individual audio characteristic of a sound for a mix, such as volume, panning, or frequency, with a distinct visual component in a 3D surround sound mixing environment. Displaying all the audio parameters together shows the relationship and the space between the sounds, which is important in a mix where there is a limited space between all of the speakers, especially in a surround sound mix.

The software solution presented herein provides visualization of all audio parameters in a mix to show placement and masking of sounds between the speakers in a mix. The software solution also provides a way to visualize automation parameters over time so that the relationship of all audio parameters can be seen at any moment in the mix timeline. Each of the features described herein can be implemented through programming of modular routines to handle audio information (including MIDI) using, for example, the C++ programming language.

A DAW (Digital Audio Workstation) is a readily available software-based tool that allows users to record, edit and produce an audio track. Some of the more popular DAWs include ProTools, Ableton Live, Cubase, Logic Pro and FL Studio. Combining the DAW with a separate computer allows the user to program and run routines to correlate sound and MIDI data to visual images, such that manipulation of the images will generate precise coordinated changes to the sound, and changes to the sound information, for example, using knobs and/or faders on a mixing board or virtual mixing board with generate precise coordinated changes to the respective visual images. The computer could be any processor-based device having adequate resources to handle audio and video processing applications, including desktop, laptop, tablet, etc.

The descriptions herein are intended to be illustrative and not limiting. Various design and path choices may be made for many of the software components and can be accommodated using the concepts and principles described herein.

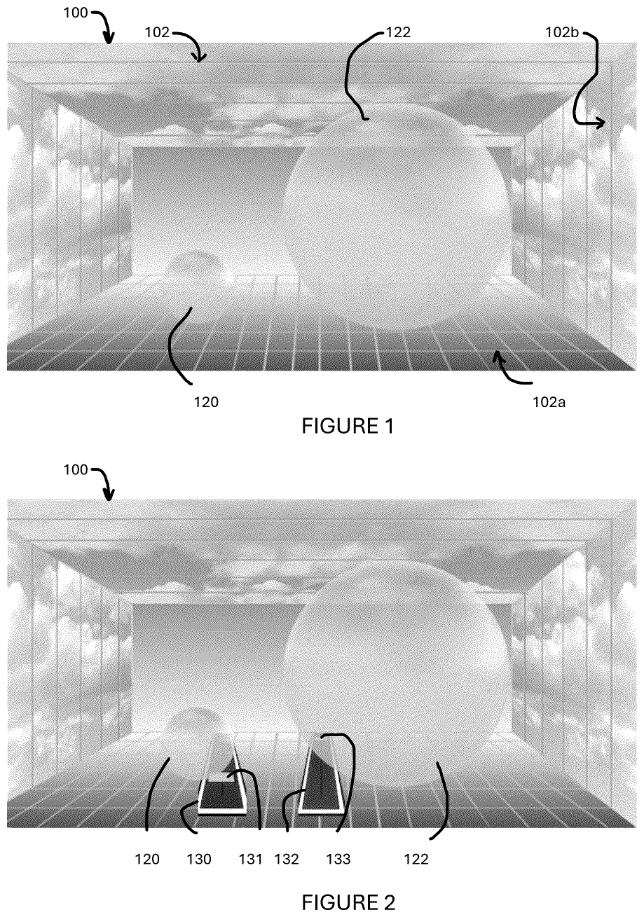

FIG. 1 illustrates a three-dimensional (3D) virtual space 100 that is computer-generated and displayed on a graphical user interface (GUI). The display is intended to be a visual representation of the volume of space between speakers (not shown), e.g., for use in a surround sound audio mix environment. In the embodiments described, it is desirable, and for some features necessary, to include a grid system 102 for defining a precise relative location within the 3D space in order to provide calibrated functionality for objects placed into the 3D space in correspondence with a characteristic feature of an audio mix. For example, the embodiment shown in FIG. 1 is a generally rectangular 3D box 100 that includes grid lines 102a on the bottom of the box defining x-coordinate and y-coordinate dimensional references; and grid lines 102b providing y-coordinate dimensional reference on the sides. The 3D space 100 and associated grid system 102 can be configured and/or customized as desired to space and dimensional matches to a known studio layout or stage layout or any other desired design.

Sounds are captured as source audio signals from various types of inputs including voice (through microphone); musical instruments; hard drives; etc. Each source audio signal has its core audio characteristics, most basically frequency (pitch), amplitude (volume/intensity), and timbre (waveform/tone quality) and duration. The various audio channels for the audio mix are represented in virtual space 100 by dynamic visual images or objects that are calibrated by a processing routine to one or more characteristics of the audio input signal. For example, a first sphere 120 on the left of the virtual space 100 is an object that represents a first audio input channel and a second sphere 22 on the right represents a second audio input channel. The spheres 120, 122 are generated such that the size of each object is precisely calibrated to the volume of the input signal for that channel. In this case, the first sphere 120 is smaller and represents a lower volume in the mix for a first channel, and the second sphere 122 is larger and represents a higher volume in the mix for a second channel.

By tying size of the object to channel volume, important information is shown regarding the masking of sounds—for example, where one sound is hidden or masked behind another sound in the mix, a common problem when trying to create a clear audio mix. Further, the graphical image is also configured with functionality to control the corresponding audio characteristic by correlating a specific visual characteristic of the object to a specific audio parameter of the audio signal. Thus, if the size of a sphere is made larger by manipulating the image in the user interface, then the volume of that sound for that corresponding channel is raised in the audio mix, and if the size of a sphere is made smaller, then the volume for that channel is decreased in the mix. Likewise, if the volume of a sound in a mix is raised with a fader (as a software tool or from an analog or digital input), the object becomes larger. If the volume of a sound in a mix is lowered with a fader, the object becomes smaller.

Of course, a full range of creative icons and graphical images could be utilized as visual objects for assignment to individual channels/instruments/media in the mix, such as any geometric shape including oblong spheres, cubes, triangles, rotating halos, etc. There could be images of instruments; or artistic images, in a moving artwork creation; or an immersive 3D entertainment display for an event or concert, as additional examples.

Referring now to FIG. 2, the 3D space 100 now includes a first fader image 130 overlaid and connected to the smaller sphere 120 and a second fader image 132 overlaid and connected to the larger sphere 122. Precise functional calibration is provided between each fader object and its corresponding sphere so that the relationship between volume and the size of the sphere can be easily understood (and adjusted) visually. The user may choose to display the faders or not. The faders 130 and 132 can be rendered in the 3D space to have potentiometer-type sliders 131 and 133, respectively, such that pushing the slider forward increases the volume for the corresponding channel and increases the size of the sphere, and bringing the slider back decreases the volume for the corresponding channel and decreases the size of the sphere. This embodiment makes it easier for those that still like to use faders to see how adjustments to channel volume affect masking in the mix. The same calibrated adjustments of visuals and audio signals can be performed using a control knob or fader on the DAW.

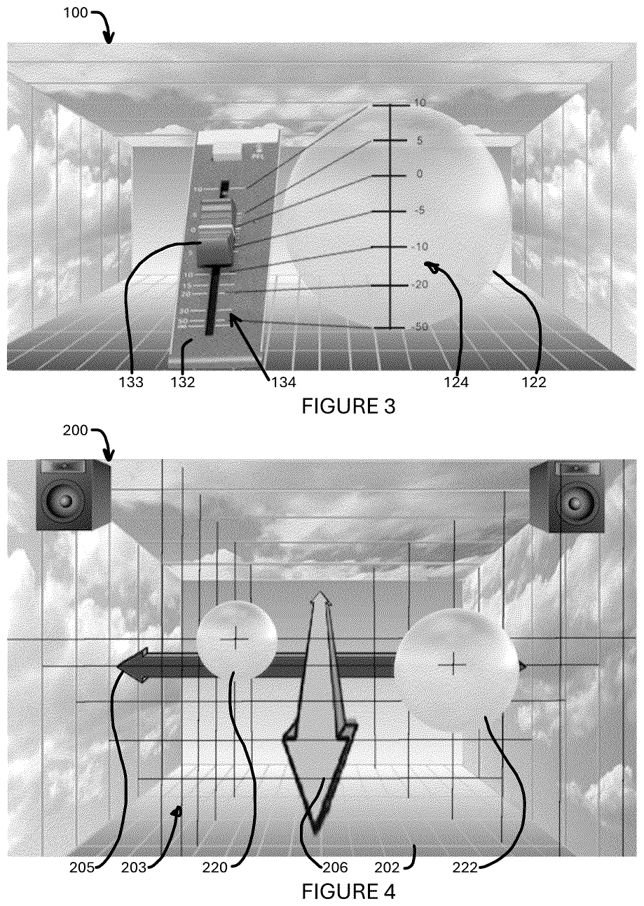

FIG. 3 shows the large sphere 122 with fader 132 attached, as in FIG. 2. In this embodiment, however, the sphere 122 and the fader 132 are both shown with calibration markings 123 and 133, respectively, in order to map the precise decibel level on the fader to a precise size of the sphere.

Mapping a precise grid in the 3D space that corresponds to panning parameters is an important step that provides critical information about the placement of the sound and its representative object in a surround sound mix, which is especially difficult when the sounds are behind the sound engineer who is facing forward in a recording studio.

FIG. 4 shows an additional (or integrated) precise grid 203 mapped over grid 202 in the 3D space 200 and calibrated for functional control of panning and frequency parameters in the x, y and z dimensions. In this mode, panning can be controlled left to right (x-dimension) in the 3D space 200, as indicated by arrow 205; front to back (y-dimension), as indicated by arrow 206; and up and down (z-dimension), as indicated by arrow 207.

The panning joystick and frequency parameters can be mapped to precise placement on the grid 203 of a sound in the mix between the surround sound speakers 204 and adjusted through DAW controls or by manipulation of the relevant visual characteristic of the channel object. Thus, if audio panning and frequency settings are moved in precisely calibrated movements, then the spatial placement of the corresponding visual objects in the 3D space on the GUI are also moved precisely. Likewise, if the spatial placement of any visual object is changed with precise movement, the audio panning and frequency parameters are changed corresponding to the spatial placement.

For example, sphere 220 is located to the left and back in this mix, and the sphere 222 is located to the right and forward in this mix, as is evident from placement of these objects on the grid, with the “plus” sign in the middle of each sphere showing the precise connection to the grid 203.

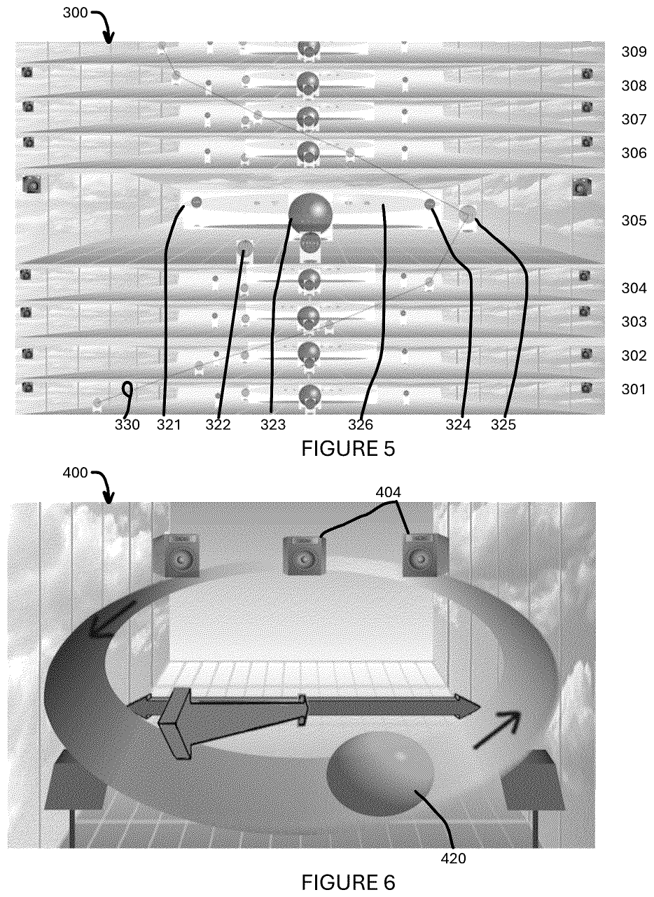

FIG. 5 shows an example audio automation sequence in 3D space 300 of multiple sound parameters visualized through multiple frames 301-308 on a timeline. This enables the user to see and understand the relationship of the sound parameters as the mix progresses.

In each frame, there are seven images: six normal spheres 320-325, and an oblong sphere 326. In this illustration, the middle frame 305 is the current time frame and shows visual images corresponding to the audio parameters of the mix at that moment. Frames 301-304 are prior in time and frame 306-309 are after in time.

If any of the 3D placement automation parameters displayed on a 3D time axis are changed using the DAW, then those changes create calibrated movement of the corresponding visuals in the 3D spatial mix, at that moment in time. Each audio parameter is uniquely calibrated to a specific visual movement and vice versa. For example, sphere 320 is all the way to left in the mix in frame 301, but the line 330 shows how the location of the sphere is changing as the mix progresses, moving the sound to the right in the mix in frames 301-305, and at the current frame 305, the sphere and corresponding sound moves back to the left in the mix in frames 306-309. Each object also has a shadow below it that helps to visualize the relative position of the object.

Showing three-dimensional aural placement of sounds at every moment of the timeline of a song allows the user to see the relationship of all the audio parameters at once, at any moment in the mix, and further, to see how those parameters change over time in the mix. This feature makes it easier to visually understand the corresponding effect on the sounds between the speakers in an audio mix and to make desirable adjustments to the mix.

In the mix time frames shown in FIG. 5, and as described above, volume corresponds to size; positional placement corresponds to panning; and average frequency and equalization corresponds to the size and height of the sphere. Further, all effect parameters are displayed. Reverb is shown as a cube; flanging, phasing and chorusing are shown as an oblong sphere with a halo rotating to the time of the modulation; fattening (delay less than 30 milliseconds) is shown as an oblong sphere corresponding to the panning of the left and right audio. All audio parameters are controllable by calibrated movement of the corresponding visual objects. The mix frames above the current time frame in the display are moments of time coming up. The user may go to any of the moments of time and control the mix at that point. Lines between any parameters show the changes. The lines may also be modified to cause changing parameters. The mixes in the front of the present moment are moments that have already passed. All parameters may also be controlled here.

Showing visuals of sounds moving to audio automation parameters makes it much easier to visualize what the audio equipment is doing to the sounds between the speakers in the mix.

FIG. 6 illustrates 3D space 400 and a representation of movement possibilities of automation parameters in the visual space between the speakers 404. If a channel icon, be it a sphere, oblong sphere, modulation sphere, or reverb cube, is moved in any direction in the 3D space between the speakers in the surround sound mix, and Automation Record is enabled in the DAW, that automation will be recorded, which can then be played back to cause the movement on its own. For example, sphere 420 can be moved in a circular pattern, as shown, back to front and back again, for a recorded automation.

For example, a precise geometrical movement can be configured and saved as a unique automation preset to create a template for programmed changes in multiple audio parameters of sounds in the mix. In our preferred embodiment, panning is correlated to lateral placement of the sound/channel icon in the 3D space, volume is correlated to size of the icon, and frequency is correlated to vertical placement of the sound/channel icon in the 3D space. Automating multiple parameters of sound at once can generate an archetypal 3D geometrical pattern. Using these geometrical patterns to control multiple audio parameters at once is much easier than having to program each of the parameters separately.

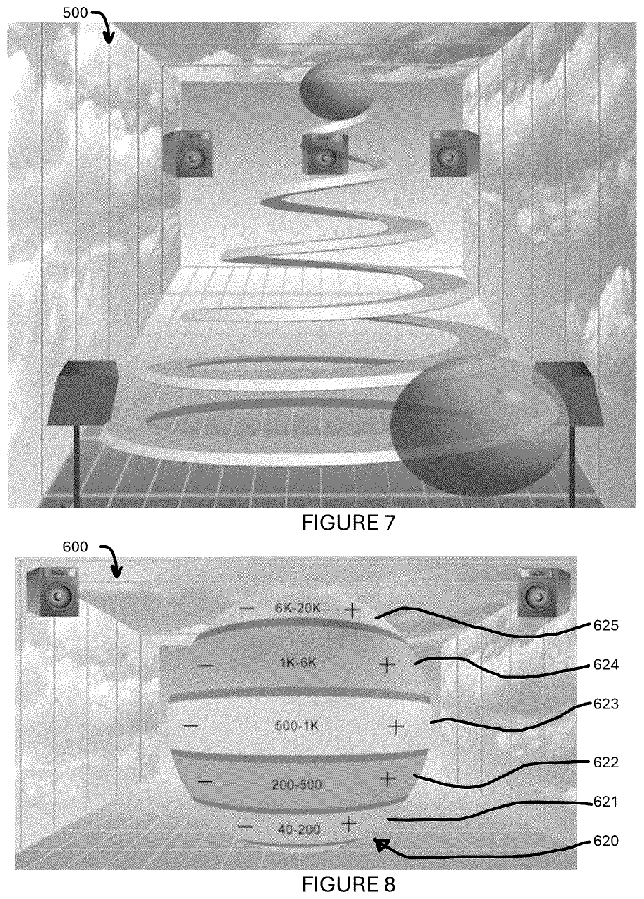

FIG. 7 shows an example of a geometrical automation preset of multiple audio parameters in the visual space between the speakers at once. Of course, many different combinations of audio parameters could be configured and stored as presets. In this example, sphere 520 is starting at the front right, and its panning parameter is configured to make smaller and smaller circles as the mix progresses, while at the same time the equalizer is configured to add more highs and turn down the lows to raise the image of the sound between the speakers to the end point (of this sequence). Manipulating these two parameters (panning and frequency) simultaneously in this way creates an upward spiral effect that may be applied to any sound/channel in the mix. Thus, when enabled in the DAW, the automation is created by manipulating the sphere and other channel images.

The display 600 shown in FIG. 8 illustrates a sphere 620 having five distinct bands 621-625 corresponding to different frequency ranges and represents characteristics of the sound itself as well as MIDI data. The bands can be presented in color, and are mapped onto the sphere 620 to show the harmonic structure of the sound itself and all equalization parameters. If a sound has harmonics in a certain frequency range, the corresponding color band gets brighter precisely based on the amplitude of the harmonics. If the user changes the volume of an equalizer on any band the band will get brighter or dimmer based on whether the volume is turned up or down on that band respectively. Therefore, the overall brightness of any frequency band is a combination of both the harmonic content and the equalization. The user may also turn up or down the volume of the equalizer by clicking or touching (in virtual reality) the plus or minus side of the band to effect a corresponding volume change in that frequency range. The width of the bands may also be changed corresponding to equalization bandwidth settings.

When the width of the bands of color are adjusted visually, the bandwidth setting on an equalizer is adjusted accordingly. If the bandwidth on an equalizer is changed, the color bandwidth is adjusted accordingly on the sound image. The size of sphere also changes based on the harmonic content and equalization. More high frequencies on average create a smaller sphere. More low frequencies on average create a larger sphere. Changes in size based on harmonic structure of the sound may be set to occur at any duration of time ranging from each moment to the whole duration of the song.

Using bands of color to show the harmonic content of sound is helpful when comparing one sound to another and how they overlap in the frequency spectrum. This is especially useful when coupled with surround placement panning because it shows where masking occurs in a particular frequency range in an entire mix. Showing the brightness of each band on the sound image corresponding to an equalizer makes it easier to see how an equalizer is actually affecting the placement of the sound.

When harmonic structure and equalization are both shown visually on the sound image at the same time, it shows how the user can only use equalization on frequencies that are present. This is very helpful for a recording engineer—especially those that are new to the field.

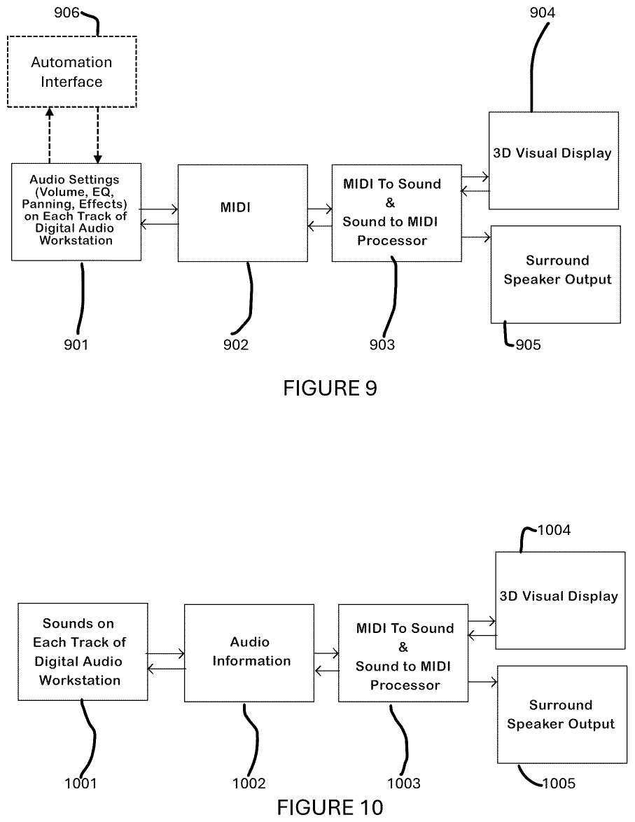

Referring now to FIGS. 9-10, simplified block diagrams illustrate different possibilities for appropriate signal flows. In FIG. 9, flow 900 includes block 901, where the audio setting information, namely volume, equalization, panning and effects, from each channel or track of a DAW generates MIDI data in block 902, which is correlated with a sound by a correlation routine executed in the processor in block 903. An image (or icon) is then correlated with the sound and rendered on a 3D display in block 904, and the audio output is sent to studio monitors in block 905.

The signal flow 900 works in reverse also. Manipulation of the image of the sound/channel on the display in block 904 causes a correlated change in the MIDI data by the correlation routine in block 903, the MIDI data is sent to block 902 then back to the DAW to make the corresponding change in the audio settings in block 901.

In an optional variation, a separate automation interface 906 is connected to the DAW to create, edit and record automation sequences that are then stored on the DAW

FIG. 10 illustrates a similar flow 1000 for the sounds themselves rather than the MIDI data. Block 1001 represents the sound information from each track in the DAW, which is extracted in block 1002, then processed into MIDI data, and correlated with the corresponding channel object in block 1003, and the object is rendered on the display in block 1004.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

1. A method for mixing surround sound audio in a system having a digital audio workstation (DAW) coupled to a processor-based device, a graphical user interface (GUI), and a surround sound speaker system, comprising:
generating a three-dimensional virtual space on the GUI to represent the surround sound speaker system, the virtual space having a width, a height and a depth;
receiving a plurality of audio signals, each of the audio signals received into a respective one of a plurality of audio channels, each of the audio signals has a plurality of audio characteristics;
defining a graphical image for each audio channel, each of the graphical images having a plurality of visual characteristics, each of the visual characteristics is dynamically correlated for bidirectional calibrated adjustment with a respective one of the plurality of audio characteristics with;
playing a plurality of sounds through the surround sound speaker system, the plurality of sounds representing a mix of the plurality of audio channels;
displaying the graphical images corresponding to each of the plurality of audio channels on the GUI while playing the mix;
adjusting the mix for a selected audio channel by either:
manipulating at least one of the visual characteristics of the graphical image for the selected channel by using the GUI thereby also changing the dynamically correlated audio characteristic; or
manipulating at least one of the audio characteristics of the selected channel by operating a DAW control for the at least one audio characteristic thereby also changing the dynamically correlated visual characteristic of the graphical image; and
storing the adjusted mix.

2. The method of claim 1, further comprising:
adjusting the mix while running an automation sequence; and
displaying a plurality of time frames of the automation sequence on the GUI, including the current time frame and the next time frame.

3. The method of claim 2, further comprising:
recording the automation sequence while adjusting the mix; and
storing the adjusted mix as a mix template.

4. The method of claim 1, further comprising:
correlating a size of the graphical image in the virtual space with a volume of the audio signal.

5. The method of claim 1, further comprising:
correlating a position of the graphical image in the virtual space with a pan of the audio signal.

6. The method of claim 1, further comprising:
correlating each one of a plurality of audio effects to a distinct visual characteristic of the graphical image.

7. The method of claim 1, further comprising:
imposing a plurality of distinct frequency bands onto the graphical image, each frequency band representing a range of frequencies of the audio signal for the selected channel.

8. The method of claim 7, further comprising:
correlating a brightness of each distinct band with an amplitude of the range of frequencies.

9. The method of claim 7, further comprising:
correlating a height of each distinct band with equalization of the channel.

10. The method claim 1, further comprising:
providing a visual indication on the graphical image of a means to increase or decrease visual characteristic and its correlated audio characteristic.

11. A system for mixing surround sound audio, comprising:
a digital audio workstation (DAW) having a plurality of audio channels, each audio channel having an input for receiving an audio signal and an output for transmitting an output signal into a multichannel audio mix, and a plurality of DAW controls for each one of the plurality of audio channels, each DAW control configured to adjust a respective one of a plurality of audio parameters associated with an audio signal or a a plurality of audio effects associated with the audio signal; and
a computer-based device coupled to the DAW via an audio interface and programmed to
(i) display a virtual three-dimensional space on a graphical user interface (“GUI”) representing a surround sound environment,
(ii) display a plurality of visual objects on the GUI, each visual object associated with a respective one of the plurality of audio channels, each visual object having a plurality of visual characteristics;
(iii) correlate each of the visual characteristics with its respective audio parameter such that modification of a visual characteristic causes a calibrated adjustment of the corresponding audio parameter and modification of the audio parameter with a DAW control causes a calibrated adjustment of the corresponding visual characteristic;
(iv) receive a selection of at least one of the audio channels;
(v) detect an adjustment to a selected visual characteristic of the visual object associated with the selected channel thereby causing a calibrated adjustment of the corresponding audio parameter; and
(vi) detect an adjustment to an audio parameter with a DAW control thereby causing a calibrated adjustment of the corresponding visual characteristic of the corresponding visual object.

12. A computer-readable medium storing instructions that, when executed by a processor, cause the processor to perform the following method:
(i) display a virtual three-dimensional space on a graphical user interface (“GUI”) representing a surround sound environment,
(ii) display a plurality of visual objects on the GUI, each visual object associated with one of a plurality of audio channels, each visual object having a plurality of visual characteristics;
(iii) correlate each of the visual characteristics with its respective audio parameter such that modification of a visual characteristic causes a calibrated adjustment of the corresponding audio parameter and modification of the audio parameter causes a calibrated adjustment of the corresponding visual characteristic;
(iv) receive a selection of at least one of the audio channels;
(v) detect an adjustment to a selected visual characteristic of the visual object associated with the selected channel thereby causing a calibrated adjustment of the corresponding audio parameter; and
(vi) detect an adjustment to a selected audio parameter thereby causing a calibrated adjustment of the corresponding visual characteristic of the corresponding visual object.
